(19) United States
(12) Patent Application Publication
(10) Pub. No.: US 2023/0390678 A1
(43) Pub. Date: Dec. 7, 2023

(54) CORE-SHEATH FIBERS, NONWOVEN FIBROUS WEB, AND FILTERING ARTICLES INCLUDING THE SAME

(71) Applicant: 3M INNOVATIVE PROPERTIES COMPANY, St. Paul, MN (US)

(72) Inventors: Nathan E. Schultz, Woodbury, MN (US); Zackary J. Becker, Minneapolis, MN (US); Daniel C. Duan, St. Paul, MN (US); Himanshu Jasuja, Woodbury, MN (US); Seth M. Kirk, Minneapolis, MN (US); Fuming B. Li, Woodbury, AA (US); John M. Sebastian, Oakdale, MN (US); Georgiy Teverovskiy, St. Louis Park, MN (US)

(21) Appl. No.: 18/249,989

(22) PCT Filed: Nov. 1, 2021
(86) PCT No.: PCT/IB2021/060101

§ 371 Date: Apr. 21, 2023

Related U.S. Application Data
(60) Provisional application No. 63/108,561, filed on Nov. 2, 2020.

(51) Int. Cl. B01D 39/16; D01F 8/06; D01F 8/16; D04H 1/4382; D04H 3/007

(52) U.S. Cl. CPC B01D 39/1623; D01F 8/06; D01F 8/16; D04H 1/43828; D04H 3/007; A62B 23/02

(57) ABSTRACT

Described herein is a thermoplastic core-sheath fiber. The thermoplastic core-sheath fiber comprises a core having a coextensive sheath layer disposed thereon, wherein the core comprises a first polymeric resin and an electrostatic charge enhancing additive, and the sheath layer comprising a second polymeric resin, with the proviso that if the second polymeric resin comprises poly(4-methyl-1-pentene), then the second polymeric resin does not comprise 100 wt % of poly(4-methyl-1-pentene). These thermoplastic core-sheath fibers can be used in filtering applications.

### TECHNICAL FIELD

The present disclosure broadly relates to nonwoven fibrous webs containing charge-enhancing additives, and articles including them.

### SUMMARY

Electrets are a dielectric material that possess a permanent or semi-permanent electric charge or dipole polarization. Electrets are useful in a variety of devices including, e.g. cling films, air filters, filtering facepieces, and respirators, and as electrostatic elements in electro-acoustic devices such as microphones, headphones, and electrostatic recorders.

Typically, the electrets are made incorporating a charging additive into a polymeric material and then inducing a charge onto the polymeric materials using a corona treatment, a tribocharging treatment, a hydrocharging treatment, or combinations thereof. Both corona treatment, tribocharging, and hydrocharging are considered surface treatment techniques. Therefore, when making fibrous electrets, the charge enhancing additives, used to make the quasi-permanent charges, are placed in the surface layer (see U.S. Pat. No. 4,375,718 (Wadsworth et al.) and JP Publ. No. 2008150753 (Hane et al.). In the present application, it has been unexpectedly discovered that a charging additive added to the core of a core-sheath fiber can generate an electret.

In one aspect, a thermoplastic core-sheath fiber is disclosed. The thermoplastic core-sheath fiber comprising: a core having a coextensive sheath layer disposed thereon, wherein the core comprises a first polymeric resin and an electrostatic charge enhancing additive, and the sheath comprising a second polymeric resin, with the proviso that if the second polymeric resin comprises poly(4-methyl-1-pentene), then the second polymeric resin does not comprise 100 wt % of poly(4-methyl-1-pentene).

In one embodiment, the thermoplastic core-sheath fiber disclosed herein can be used in a filtering article, such as a respirator.

In another aspect, a method of making an electret is described. The method comprising: providing a thermoplastic core-sheath fiber comprising a core having a coextensive sheath layer disposed thereon, wherein the core comprises a first polymeric resin and an electrostatic charge enhancing additive and the sheath comprises a second polymeric resin, with the proviso that if the second polymeric resin comprises poly(4-methyl-1-pentene), then the second polymeric resin does not comprise 100 wt % of poly(4-methyl-1-pentene); and charging the thermoplastic core-sheath fiber via corona treatment, hydrocharging, tribocharging, or combinations thereof to form the electret.

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

FIG. 1 is a schematic cross-sectional view of an exemplary core-sheath fiber according to the present disclosure.

FIG. 2 is a schematic perspective view of a nonwoven fibrous web according to the present disclosure.

FIG. 3 is a schematic front view of an exemplary respirator 40 according to one embodiment of the present disclosure.

FIG. 4 is a schematic cross-sectional view of mask body 42 in FIG. 3.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

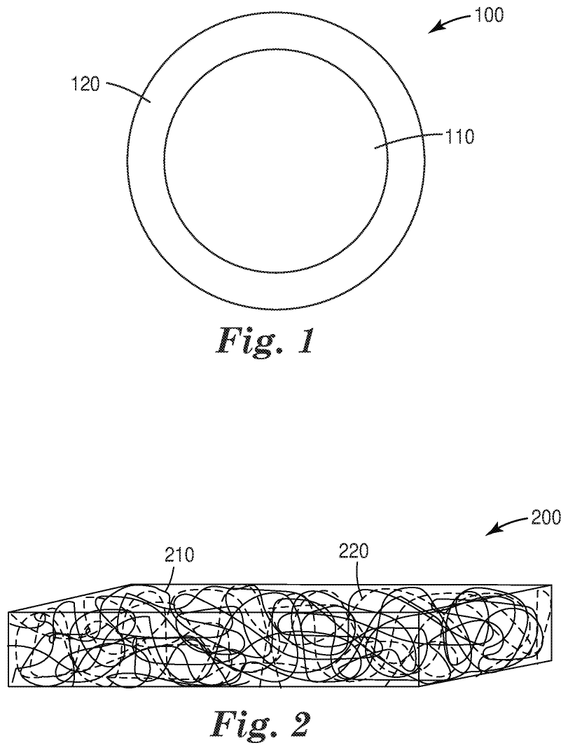

Referring now to FIG. 1, core-sheath fiber 100 comprises a core 110 having a sheath layer 120 disposed thereon. While not shown, the sheath layer 120 is coextensive along the fiber length (fiber ends excluded). While the core-sheath fiber and the core shown in FIG. 1 have circular cross-sections, other cross-sections may also be used such as, for example, triangular, square, rectangular, pentagonal, hexagonal, heptagonal, octagonal, star-shaped, oval, trilobal, and tetralobal. Likewise, while FIG. 1 shows a centrally located core, it may be located off-center.

In one embodiment, the core-sheath fibers of the present disclosure are not so called “islands-in-the-sea” extrudates, wherein multiple fiber cores (i.e., more than 1, 2, 4, or even 6 cores) are distributed within a polymer matrix, which also forms the sheath.

Thermoplastic resins useful in the core of the present disclosure include any thermoplastic nonconductive polymer capable of retaining a high quantity of trapped electrostatic charge when formed into a web and charged. Typically, such polymeric resins have a DC (direct current) resistivity of greater than 10¹⁴ ohm-cm at the temperature of intended use. Polymers capable of acquiring a trapped charge include polyolefins such as polypropylene; polyethylene (e.g., HDPE, LDPE, LLDPE, VLDPE; ULDPE, UHMW-PE grades); poly(1-butene); poly(3-methylbutene); poly(4-methyl-1-pentene; polyvinyl chloride; polystyrene; polycarbonates; polyesters, including polylactides; and perfluorinated polymers and copolymers. Preferably, the thermoplastic resin comprises polypropylene.

Examples of suitable thermoplastic resins include, for example, the polypropylene resins: ESCORENE PP 3746G commercially available from Exxon-Mobil Corporation, Irving, TX; TOTAL PP3960, TOTAL PP3860, and TOTAL PP3868 commercially available from Total Petrochemicals USA Inc., Houston, TX; and METOCENE MF 650 W commercially available from LyondellBasell Industries, Inc., Rotterdam, Netherlands; and the poly-4-methyl-1-pentene resin TPX-DX820, TPX-DX470, and TPX-MX002 commercially available from Mitsui Chemicals, Inc., Tokyo, Japan.

In the present disclosure, the core of the fiber contains an electrostatic charge enhancing additive. Many charge enhancing additives for making electret-containing fiber webs are known in the art. Charge enhancing additives are materials that either increase the initial Quality Factor (Q0) discussed below and/or increase the charge stability (ratio of Q3/Q0) for webs made with the core-sheath-fibers. Exemplary electrostatic charge enhancing additives may include pigments, light stabilizers, primary and secondary antioxidants, metal deactivators, hindered amines, hindered phenols, metal salts, phosphite triesters, phosphoric acid salts, fluorine-containing compounds, and combinations thereof. Preferably, the charge enhancing additive is a solid at ambient conditions to prevent migration within the resin and does not decompose at moderate temperatures. In one embodiment, the charge enhancing additive is a solid at temperatures of at least 25, 30, 40, 50, 60, 80 or even 100° C. In one embodiment, the charge enhancing additive does not decompose, for example, there is no significant weight loss (i.e., less than 5, 1, or even 0.1 wt %) when measured under nitrogen by thermogravimetric analysis using a ramp rate of 10° C./min to heat up to 235° C.

Particularly preferred change enhancing additives include hindered amine-based additives, triazine-based additives, and hindered phenol-based additives.

Specific examples of the hindered amine-based or triazine-based additives include (poly[[6-(1,1,3,3,-tetramethylbutyl) amino]-s-triazine-2,4-diyl][[(2,2,6,6-tetramethyl-4-piperidyl) imino]hexamethylene [(2,2,6, 6-tetramethyl-4-piperidyl) iminol]), available under the trade designation “CHIMASSORB 944” from BASF, Ludwigshafen, Germany; dimethyl succinate-1-(2-hydroxyethyl)-4-hydroxy-2,2,6,6-tetramethylpiperidine polycondensate, available under the trade designation “TINUVIN 622” from BASF; di-tert-butyl-4-hydroxybenzyl)-2-n-butyl malonate bis(1,2,2,6,6-pentamethyl-4-piperidyl available under the trade designation “TINUVIN 144” from BASF; a polycondensate of dibutylamine-1,3,5-triazine-N,N′-bis(2,2,6,6-tetramethyl-4-piperidyl-1,6-hexamethylenediamine-N-(2,2,6,6-tetramethyl-4-piperidyl)butylamine, available under the trade designation “CHIMASSORB 2020” from BASF; 2-(4,6-diphenyl-1,3,5-triazin-2-yl)-5-((hexyl)oxy)-phenol, available under the trade designation “TINUVIN 1577” from BASF; N-substituted amino aromatic compounds, particularly tri-amino substituted compounds, such as 2,4,6-trianilino-p-(carbo-2′-ethylhexyl-1′-oxy)-1,3,5-triazine, available under the trade designation “IUVINUL T-150” from BASF; and 2,4,6-tris-(octadecylamino)triazine, also known as tristearyl melamine (“TSM”).

Hindered phenol-based additives having a hydroxyl group as the terminal functional group. The hindered phenol-based additives are not particularly limited, and specific examples include pentaerythrityl-tetrakis[3-(3,5-di-tert-butyl-4-hydroxyphenyl)propionate] (Irganox 1010, manufactured by BASF), octadecyl-3-(3,5-di-tert-butyl-4-hydroxyphenyl) propionate (Irganox 1076, manufactured by BASF), tris-(3,5-di-tert-butyl-4-hydroxybenzyl)-isocyanurate (Irganox 3114, manufactured by BASF), 3,9-bis-{2-[3-(3-tert-butyl-4-hydroxy-5-methylphenyl)-propionyloxy]-1,1-dimethylethyl}-2,4,8,10-tetraoxaspiro-[5,5]undecane (Sumilizer-GA-80, manufactured by Sumitomo Chemical Co., Ltd.), and the like.

Additional thermally stable organic triazine compounds or oligomers, where compounds or oligomers contain at least one nitrogen atom in addition to those in the triazine ring, are disclosed in U.S. Pat. Nos. 6,268,495; 5,976,208; 5,968,635; 5,919,847; and U.S. Pat. No. 5,908,598 to Rousseau et al.

Further examples of charge-enhancing additives are provided in U. S. Publ. Pat. Appln. No 2011/0137082 (Li et al.); U.S. Pat. No. 8,613,795 (Li et al.), U.S. Pat. No. 7,390,351 (Leir et al.), U.S. Pat. No. 5,057,710 (Nishiura et al.), and U.S. Pat. Nos. 4,652,282 and 4,789,504, both to Susumu et al., and U.S. Pat. No. 8,790,449 B2 (Li et al.).

The charge-enhancing additive(s) can be added in any suitable amount. The charge-enhancing additives of this disclosure may be effective even in relatively small quantities. Typically, the charge-enhancing additive is present in a thermoplastic resin and charge-enhancing additive blend in amounts of up to about 10% by weight, more typically in the range of 0.02 to 5% by weight based upon the total weight of the blend. In some embodiments, the charge-enhancing additive is present in an amount ranging from 0.1 to 3% by weight, 0.1 to 2% by weight, 0.2 to 1.0% by weight, or 0.25 to 0.5% by weight.

Blends of the thermoplastic resin and the charge-enhancing additive can be prepared by well-known methods. The charge-enhancing additive may be directly added to the thermoplastic resin to form the core, or alternatively, the charge-enhancing additive is concentrated in a thermoplastic resin in a so-called masterbatch, and the masterbatch then is added to the thermoplastic resin to form the core. In the instance of the masterbatch, the thermoplastic resin of the masterbatch may be different from the thermoplastic resin forming the core. In one embodiment, the charge-enhancing additive is in an amount of 10 to 30 wt % in the masterbatch. Typically, the blend of the charge-enhancing additive and a thermoplastic resin is processed using melt extrusion techniques, so the blend may be preblended to form pellets in a batch process, or the thermoplastic resin and the charge-enhancing additive may be mixed in the extruder in a continuous process. Where a continuous process is used, the thermoplastic resin and the charge-enhancing additive may be pre-mixed as solids or added separately to the extruder and allowed to mix in the molten state.

Examples of melt mixers that may be used to form preblended pellets include those that provide dispersive mixing, distributive mixing, or a combination of dispersive and distributive mixing. Examples of batch methods include those using a BRABENDER (e. g. a BRABENDER PREP CENTER, commercially available from C.W. Brabender Instruments, Inc.; South Hackensack, New Jersey) or BANBURY internal mixing and roll milling equipment (e.g. equipment available from Farrel Co.; Ansonia, Connecticut). After batch mixing, the mixture created may be immediately quenched and stored below the melting temperature of the mixture for later processing.

Examples of continuous methods include single screw extruding, twin screw extruding, disk extruding, reciprocating single screw extruding, and pin barrel single screw extruding. The continuous methods can include utilizing both distributive elements, such as cavity transfer mixers (e.g., CTM, commercially available from RAPRA Technology, Ltd.; Shrewsbury, England) and pin mixing elements, static mixing elements or dispersive mixing elements (commercially available from e.g., MADDOCK mixing elements or SAXTON mixing elements).

Examples of extruders that may be used to extrude preblended pellets prepared by a batch process include the same types of equipment described above for continuous processing. Useful extrusion conditions are generally those which are suitable for extruding the resin without the additive.

The core may have any average diameter, but preferably is in a range of from 1 to 100 microns, more preferable 5 to 50 microns, and even more preferably 10 to 25 microns.

The core is encapsulated by a sheath layer. The sheath layer forms a coextensive layer with the outer surface of the fiber core, exclusive of the ends of the fiber core which may or may not be coated with the sheath layer. While not a requirement, the sheath layer is preferably substantially uniform and complete. In one embodiment, the sheath layer may be thin for example having a thickness of at least 0.05, 0.1, 0.2, 0.4, 0.5, or even 0.6 microns; and at most 0.8, 1.0, 1.5, 2.0, 2.5, 2.8, or even 3.0 microns in average thickness. In one embodiment, the volume ratio of the core to sheath is at least 60:40, 70:30, or even 75:25. In one embodiment, the volume ratio of the core to sheath is at most 80:20, 85:15, 90:10, or even 95:5. In one embodiment, the weight percent of the sheath layer in the core-sheath fiber is at least 3, 5, 8, 10, 15, or even 25 wt %. In one embodiment, the weight percent of the sheath layer in the core-sheath fiber is at most 30, 40, 50, 60, or even 70 wt %.

The sheath layer comprises a thermoplastic polymer. Exemplary thermoplastic polymers include styrenic block copolymers (e.g., SIS, SEBS, SBS), thermoplastic polyolefins, elastomeric alloys (e.g., elastomeric thermoplastic acrylate block copolymers such as polymethyl methacrylate-block-poly(butyl acrylate)-block-polymethyl methacrylate commercially available as Kurarity from Kuraray Company, Ltd., Okayama, Japan), thermoplastic polyurethanes (TPUs), thermoplastic polyesters and copolyesters; polyvinyl chloride; polystyrene; polycarbonates; thermoplastic polyesters (e.g., polylactides and polyethylene terephthalate); perfluorinated polymers and copolymers, thermoplastic polyamides, and blends of any of the foregoing.

Thermoplastic copolyesters can be useful as the thermoplastic polymer. Particularly useful are thermoplastic aliphatic polyesters which may further include polylactic acid, polycaprolactone, and other biodegradable polymers. Melt-processable (filament-forming) polylactic acid polymer materials (e.g., L-D copolymers) are commercially available e.g., from NatureWorks LLC of Minnetonka, Minnesota, under the trade designations INGEO 6100D, 6202D, and 6260D. Melt-processable polylactic acid polymer materials (e.g., D-lactic acid homopolymers) are available, e.g., under the trade designation “SYNTERRA PDLA 1010” from Synbra Technologies, The Netherlands. Many other potentially suitable polylactic acid materials are also available.

Exemplary thermoplastic polyurethanes (TPUs) include polyester-based TPUs and polyether-based TPUs. One exemplary polyester-based thermoplastic polyurethane can be obtained as IROGRAN (model PS 440-200) from The Huntsman Corporation (The Woodlands, Texas). Exemplary polyether TPU resins include those commercially available as Estane from B.F. Goodrich Company (Cleveland, Ohio).

Exemplary thermoplastic polyolefins include homopolymers and copolymers of propylene, ethylene, 1-butene, 1-hexene, 1-octene, 1-decene, and 1-octadecene. Of these, homopolymers and copolymers of ethylene and/or propylene are preferred, with propylene being generally preferred. Representative examples include polyethylene (e.g., HDPE, LDPE, LLDPE, VLDPE; ULDPE, UHMW-PE grades), polypropylene, poly(1-butene), poly(3-methylbutene), and copolymers of olefinic monomers discussed herein.

In one embodiment, the first polymeric resin of the core is the same as the second polymeric resin used in the sheath. In another embodiment, the first polymeric resin of the core is different from the second polymeric resin used in the sheath.

In one embodiment, the polymeric resin of the sheath (or second polymeric resin) comprises poly(4-methyl-1-pentene. In one embodiment, the polymeric resin of the sheath comprises less than 100, 99, 98, 97, 95, 90, 85, 80, or even 75 wt % of poly(4-methyl-1-pentene. In one embodiment, the polymeric resin of the sheath is substantially free of 4-methyl-1-pentene or a polymer thereof (e.g., poly(4-methyl-1-pentene)), meaning that it comprises less than 10, 8, 6, 5, 4, 3, 2, 1, 0.5, or even 0.1 wt %.

In one embodiment the core-sheath fibers are substantially free of a polyarylene sulfide, in other words, the core-sheath fibers comprise less than 10, 8, 6, 5, 4, 3, 2, 1, 0.5, 0.1, or even 0.01 wt % of polyarylene sulfide in the sheath portion, the core portion, or the core-sheath fiber.

In one embodiment the core-sheath fibers are substantially free of polytetrafluoroethylene, in other words, the core-sheath fibers comprise less than 10, 8, 6, 5, 4, 3, 2, 1, 0.5, 0.1, or even 0.01 wt % of polytetrafluoroethylene in the sheath portion, the core portion, or the core-sheath fiber.

The sheath should be substantially free (less than 0.1, 0.05, or even 0.01 wt %) from materials such as antistatic agents, which could increase the electrical conductivity or otherwise interfere with the ability of the core of the fiber to accept and hold electrostatic charges.

In one embodiment, the sheath is substantially free (comprising less than 0.1, or even 0.01 wt %) of an electrostatic charge enhancing additive.

In one embodiment, the sheath also comprises an electrostatic charge enhancing additive.

The sheath and core have different compositions, wherein the core may comprise a different thermoplastic resin and/or a different charge enhancing additive than the sheath layer.

In one embodiment, the core and/or sheath may comprise one or more conventional adjuvants such as antioxidants, light stabilizers, plasticizers, acid neutralizers, fillers, antimicrobials, surfactants, antiblocking agents, pigments, primers, dispersants, and other adhesion promoting agents. It may be particularly beneficial for medical applications to incorporate the antimicrobials and enhancers discussed in U.S. Pat. No. 7,879,746 (Klun et al.), incorporated herein by reference. It may be particularly beneficial for certain applications to incorporate surfactants discussed in U. S. Pat. Appl. Publ. No. 2012/0077886 (Scholz et al.), incorporated herein by reference.

In one embodiment, advantageously, the core-sheath fibers of the present disclosure may have better performance (such as longevity and/or filtering ability) due to the charge enhancing additive located in the core of the fiber.

In one embodiment, an additive compound may be added to the sheath to alter the surface of the core-sheath fiber. For example, fluorinating the core-sheath fiber. In one embodiment a fluorinated compound (such as fluorinated compounds available as Repellent Polymer Melt Additive PM-870, from 3M Co., Maplewood, MN) may be added to the polymeric resin of the sheath layer. In another embodiment, the core-sheath fiber can be placed in an atmosphere that contains a fluorine-containing species and an inert gas and then applying an electrical discharge to modify the surface chemistry of the sheath layer. The electrical discharge may be in the form of a plasma such as an AC corona discharge. This plasma fluorination process causes fluorine atoms to become present on the surface of the polymeric article. The plasma fluorination process is described in a number of U.S. Pat. Nos. 6,397,458; 6,398,847; 6,409,806; 6,432,175; 6,562,112; 6,660,210; and U.S. Pat. No. 6,808,551 to Jones/Lyons et al. Electret articles that have a high fluorosaturation ratio are described in U.S. Pat. No. 7,244,291 (Spartz et al.), and electret articles that have a low fluorosaturation ratio, in conjunction with heteroatoms, is described in U.S. Pat. No. 7,244,292 (Kirk et al.). Other publications that disclose fluorination techniques include: U.S. Pat. Nos. 6,419,871; 6,238,466; 6,214,094; 6,213,122; 5,908,598; 4,557,945; 4,508,781; and 4,264,750; U.S. Publ. No 2003/0134515 A1 and 2002/0174869 A1; and WO Publ. No. 01/07144.

Core-sheath fibers used in practice of the present disclosure may have any average fiber diameter, and may be continuous, random, and/or staple fibers. For example, in some embodiments, the fibers (i.e., individual fibers) may have an average fiber diameter of greater than or equal to 5 microns (e.g., greater than or equal to 6 microns, greater than or equal to 8 microns, greater than or equal to 10 microns) up to 15 microns, up to 18 microns, up to 20 microns, up to 22 microns, or even up to 25 microns).

In one embodiment, the diameter of the core-sheath fiber can be determined by microscopy (e.g., optical or scanning electron microscopy), wherein the fiber is cross-sectioned and viewed under magnification to determine the diameter of the fiber, diameter of the core, and/or thickness of the sheath.

In one embodiment, the diameter of the core-sheath fiber can be calculated by a measuring the pressure drop across a fiber web. The effective fiber diameter (EFD) can be calculated as set forth in C. N. Davies, The Separation of Airborne Dust and Particulates, Institution of Mechanical Engineers, London Proceedings, IB (1952). In practice, the sheath thickness may show some experimental variation as a result of routine experimental variation and the averaging nature of EFD.

Methods for making core-sheath fibers are well known and need not be described here in detail. In one embodiment, the core-sheath fibers are made by co-extrusion. For example, at least two polymers are extruded separately and fed to a polymer distribution system where the polymers are introduced into a segmented spinneret plate. The polymers follow separate paths and are combined in a spinneret hole thus providing a core-sheath type fiber. See, for example, U.S. Pat. No. 4,789,592 (Taniguchi et al.) and U.S. Pat. No. 5,336,552 (Strack et al.), both of which are incorporated herein by reference in their entirety. In another embodiment, the sheath layer is deposited onto the core fiber, using deposition and coating techniques known in the art. For example, vapor deposition can be used to encase a fiber core with the sheath material above the melting temperature of the resin. Such a technique may be more useful with neat polymer resin sheaths. See for example, U.S. Pat. No. 10,213,716 (Kitagawa et al.) are incorporated herein by reference in their entirety. Coating techniques, such as spray coating, dip coating, etc., can be used to coat fiber cores with the sheath composition. See for example, WO Publ. No. 201688692 (Kitagawa)

Fibers (filaments) described herein can generally be made using techniques known in the art for making filaments. Such techniques include wet spinning, dry spinning, melt spinning, melt blowing, or gel spinning.

Particularly advantageous to form core-sheath filaments is melt spinning. In melt spinning, a polymer is heated, passed through a spinneret, and fibers solidify upon cooling. For example, a melt spinning process can occur to collect the multicomponent filaments. The term “meltspun” as used herein refers to filaments that are formed by extruding molten filaments out of a set of orifices and allowing the filaments to cool and (at least partially) solidify to form filaments, with the filaments passing through an air space (which may contain streams of moving air) to assist in cooling and solidifying the filaments, and with the thus-formed fibers then passing through an attenuation (i.e., drawing) unit to draw the fibers.

Melt spinning can be distinguished from melt blowing, which involves the extrusion of molten filaments into converging high velocity air streams introduced by way of air-blowing orifices located in close proximity to the extrusion orifices. Melt spinning can also be distinguished from electrospinning in that electrospinning could be described as extruding out of a need a solvent solution. A modification of the spinneret results in multicomponent (e.g., core-sheath) fibers (See, e.g., U.S. Pat. No. 4,406,850 (Hills), U.S. Pat. No. 5,458,972 (Hagen), U.S. Pat. No. 5,411,693 (Wust), U.S. Pat. No. 5,618,479 (Lijten), and U.S. Pat. No. 5,989,004 (Cook)). Filaments according to the present disclosure can also be made by fibrillation of a film, which may provide filaments having a rectangular cross-section.

Referring now to FIG. 2, exemplary nonwoven fibrous web 200 comprises core-sheath fibers 210 and optional secondary fibers 220. Core-sheath fibers 210 have an average fiber diameter of 2 to 100 microns and comprise a core-sheath fiber according to the present disclosure. Optional secondary fibers may be any fiber type and/or have any average fiber diameter.

Nonwoven fibrous webs may be made, for example, by conventional air laid, carded, stitch bonded, spunbonded, wet laid, and/or meltblown procedures.

Spunbonded nonwoven fibrous webs can be formed according to well-known conventional methods wherein meltspun fibers are deposited on a moving belt where they form a nonwoven continuous fiber web having interfiber bonds. Meltblown nonwoven fibrous webs are made by a similar process except that high velocity gas impinges on the extruded fibers thereby stretching and thinning them before they are collected on a rotating drum. Meltblown fiber webs likewise have interfiber bonds, although the webs generally do not have the cohesive strength of corresponding spunbonded fiber webs.

In some embodiments, a nonwoven web can be made by air-laying of fibers (e.g., core-sheath fibers and optional secondary fibers). Air-laid nonwoven fibrous webs may be prepared using equipment such as, for example, that available as a RANDO WEBBER from Rando Machine Company of Macedon, New York. In some embodiments, a type of air-laying may be used that is termed gravity-laying, as described, e.g., in U. S. Pat. Application Publication 2011/0247839 to Lalouch, the disclosure of which is incorporated by reference herein. Nonwoven fibrous webs may be densified and strengthened, for example, by techniques such as crosslapping, stitchbonding, needletacking, hydroentangling, chemical bonding, and/or thermal bonding.

Nonwoven fibrous webs according to the present disclosure may have any basis weight, thickness, porosity, and/or density unless otherwise specified. In some embodiments, the nonwoven fibrous webs are lofty open nonwoven fibrous webs. In some embodiments, fibers of the nonwoven fibrous web have an effective fiber diameter of from at least 3, 4, 5, 10, 15, 20, or 25 micrometers and at most 125, 100, 90, 80, 75, 50, 40, or even 30 micrometers.

Core-sheath fiber and/or nonwoven fibrous web containing core-sheath fiber may be charged as it is formed or charged after it is formed. For electret filter media (e.g., a nonwoven fibrous web), the media is generally charged after the fiber web is formed.

In general, any standard charging method known in the art may be used. For example, charging may be carried out in a variety of ways, including tribocharging, hydrocharging, and corona discharge. A combination of methods may also be used. As mentioned above, in some embodiments, the electret webs of this disclosure have the desirable feature of being capable of being charged by corona discharge alone, particularly DC corona discharge, without the need of additional charging methods. Examples of suitable corona discharge processes are described in U.S. Pat. Re. No. 30,782 (van Turnhout), U.S. Pat. Re. No. 31,285 (van Turnhout), U.S. Pat. Re. No. 32,171 (van Turnhout), U.S. Pat. No. 4,215,682 (Davis et al.), U.S. Pat. No. 4,375,718 (Wadsworth et al.), U.S. Pat. No. 5,401,446 (Wadsworth et al.), U.S. Pat. No. 4,588,537 (Klaase et al.), U.S. Pat. No. 4,592,815 (Nakao), U.S. Pat. No. 6,365,088 (Knight et al.), British Pat. 384,052 (Hansen), U.S. Pat. No. 5,643,525 (McGinty et al.), Japanese Pat. No. 4,141,679 B2 (Kawabe et al.). Further methods are discussed by M. Paajanen et. al. in Journal of Physics D: Applied Physics (2001), vol. 34, pp. 2482-2488, and by G. M. Sessler and J. E. West in Journal of Electrostatics (1975), 1, pp. 111-123.

Another technique that can be used to charge the electret web is hydrocharging. Hydrocharging of the web is carried out by contacting the fibers with water in a manner sufficient to impart a charge to the fibers, followed by drying of the web. One example of hydrocharging involves impinging jets of water or a stream of water droplets onto the web at a pressure sufficient to provide the web with filtration enhancing electret charge, and then drying the web. The pressure necessary to achieve optimum results varies depending on the type of sprayer used, the type of polymer from which the web is formed, the type and concentration of additives to the polymer, the thickness and density of the web and whether pre-treatment, such as corona surface treatment, was carried out prior to hydrocharging. Generally, water pressures in the range of about 10 to 500 psi (69 to 3450 kPa) are suitable. The jets of water or stream of water droplets can be provided by any suitable spray device. One example of a useful spray device is the apparatus used for hydraulically entangling fibers. An example of a suitable method of hydrocharging is described in U.S. Pat. No. 5,496,507 (Angadjivand et al.). Other methods are described in U.S. Pat. No. 6,824,718 (Eitzman et al.), U.S. Pat. No. 6,743,464 (Insley et al.), U.S. Pat. No. 6,454,986 (Eitzman et al.), U.S. Pat. No. 6,406,657 (Eitzman et al.), and U.S. Pat. No. 6,375,886 (Angadjivand et al.). The hydrocharging of the web may also be carried out using the method disclosed in the U.S. Pat. No. 7,765,698 (Sebastian et al.).

It has been surprisingly discovered that core-sheath fibers comprising a charge enhancing additive in the core have an electret charge. An electret charge means that there is at least quasi-permanent electrical charge, where “quasi-permanent’ means that the electric charge is present under standard atmospheric conditions (22° C., 101,300 Pascals atmospheric pressure, and 50% relative humidity) for a time period long enough to be significantly measurable. Electric charge may be characterized by the X-ray Discharge Test as described in U.S. Pat. No. 9,815,067 (Schultz et al.) in col. 18, lines 12-42, incorporated herein by reference. Unlike an electrostatic charge that dissipates shortly thereafter (such as can be created as a result of friction), the electret charge of the (e.g. nonwoven) web articles is a quasi-permanent electric charge that is substantially maintained for the intended product life of the article. Hence, sufficient charge is evident at the time of use as well as at least 6 months or 12 months after manufacturing.

To verify that a particular filter medium is electrostatically charged in nature, one may examine its performance after exposure to ionizing x-ray radiation. As described in the literature (Air Filtration by R. C. Brown (Pergamon Press, 1993 and “Application of Cavity Theory to the Discharge of Electrostatic Dust Filters by x-Rays”, A. J. WAKER and R. C. BROWN, Applied Radiation and Isotopes, Vol 39. No. 7, pp. 677-684, 1988), if an electrostatically charged filter is exposed to x-rays, the penetration of an aerosol through the filter will be greater after exposure than before exposure, because the ions produced by the x-rays in the gas cavities between the fibers will have neutralized some of the electric charge Thus, a plot of penetration against cumulative x-ray exposure can be obtained which shows a steady increase up to a constant level after which further irradiation causes no change. At this point all of the charge has been removed from the filter.

In some embodiments, the electret charge of a (e.g. unitary) core-sheath fiber web may be characterized by exhibiting a % penetration ratio of at least 50% when tested pursuant the X-ray Discharge Test.

In other embodiments, the electret charge of the (e.g. unitary) core-sheath fiber web may be characterized by exhibiting an initial quality factor of at least 0.2 and the quality factor is at least 50% less than the initial quality factor after 40 minutes when tested pursuant the X-ray Discharge Test (as described in the examples).

Core-sheath fibers according to the present disclosure are useful, for example, in the manufacture of nonwoven filter media, and especially nonwoven electret filter media.

In one embodiment, the core sheath fiber may be included in a filtering article, including: an air filter element of a respirator, such as a filtering facepiece, or for such purposes as home and industrial air-conditioners, air cleaners, vacuum cleaners, medical air line filters, and air conditioning systems for vehicles and common equipment, such as computers, computer disk drives and electronic equipment. In some embodiments, the filtering article is combined with a respirator assembly to form a respiratory device designed to be used by a person. In respirator uses, the filtering articles may be in the form of molded, pleated, or folded half-face respirators, replaceable cartridges or canisters, or prefilters. As used herein, the term “respirator” means a system or device worn over a person's breathing passages to prevent contaminants from entering the wearer's respiratory tract and/or protect other persons or things from exposure to pathogens or other contaminants expelled by the wearer during respiration, including, but not limited to filtering face masks.

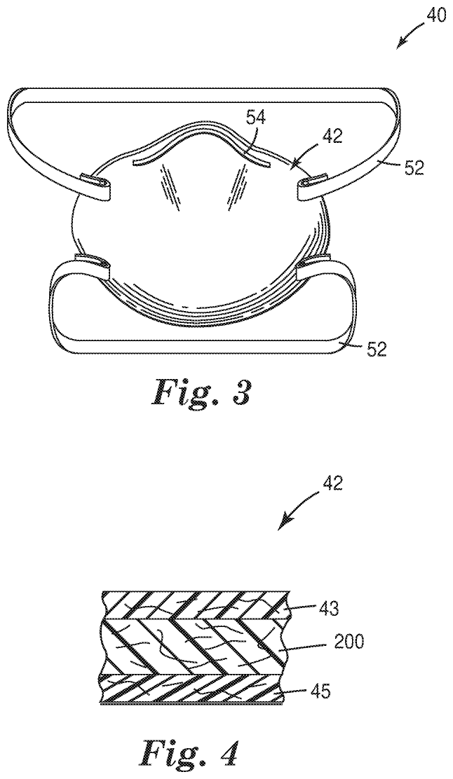

Shown in FIGS. 3 and 4 is one example of a respirator. Respirator 40 comprises mask body 42 which can be of curved, hemispherical shape or may take on other shapes as desired (e.g., see U.S. Pat. No. 5,307,796 (Kronzer et al.) and U.S. Pat. No. 4,827,924 (Japuntich)). In mask 40, electret nonwoven fibrous web (i.e., filter media) 200 according to the present disclosure is sandwiched between cover web 43 and inner shaping layer 45. Shaping layer 45 provides structure to the mask body 42 and support for filter media 200.

Shaping layer 45 may be located on either side of the filter media 200 and can be made, for example, from a nonwoven web of thermally-bondable fibers molded into a cup-shaped configuration. The shaping layer can be molded in accordance with known procedures (e.g., see U.S. Pat. No. 5,307,796 (Kronzer et al.), the disclosure of which is incorporated herein by reference. The shaping layer or layers typically are made of bicomponent fibers that have a core of a high melting materials such as polyethylene terephthalate, surrounded by a sheath of lower melting material so that when heated in a mold, the shaping layer conforms to the shape of the mold and retains this shape when cooled to room temperature. When pressed together with another layer, such as the filter layer, the low melting sheath material can also serve to bond the layers together.

To hold the mask 40 snugly on the wearer's face, masks body 42 can have straps 52, tie strings, a mask harness, etc. attached thereto. A pliable soft band 54 of metal, such as aluminum, can be provided on mask body 42 to allow it to be shaped to hold the mask 40 in a desired fitting relationship on the nose of the wearer (e.g., see U.S. Pat. No. 5,558,089 (Castiglione et al.)). Respirators according to the present disclosure may also include additional layers, valves (e.g., see U.S. Pat. No. 5,509,436 (Japuntich et al.), molded face pieces, etc. Examples of respirators that can incorporate the electret filter media according to the present disclosure include those described in U.S. Pat. No. 4,536,440 (Berg); U.S. Pat. No. 4,827,924 (Japuntich); U.S. Pat. No. 5,325,892 (Japuntich et al.); U.S. Pat. No. 4,807,619 (Dyrud et al.); U.S. Pat. No. 4,886,058 (Brostrom et al.); and RE 35,062 (Brostrom et al.).

To assess filtration performance, a variety of filtration testing protocols have been developed. These tests include measurement of the aerosol penetration of the filter web using a standard challenge aerosol such as dioctylphthalate (DOP), which is usually presented as percent of aerosol penetration through the filter web (% Pen) and measurement of the pressure drop across the filter web (ΔP). From these two measurements, a quantity known as the Quality Factor (QF) may be calculated by the following equation:

QF=−ln(% Pen/100)/ΔP,

where in stands for the natural logarithm. A higher QF value indicates better filtration performance, and decreased QF values effectively correlate with decreased filtration performance. Details for measuring these values are presented in the Examples section. Typically, the filtration media of this disclosure have measured QF values of 0.3 (mm of H₂O)⁻¹ or greater at a face velocity of 13.8 centimeters per second.

The initial Quality Factor (Q0) is typically at least 0.2 and preferably at least 0.3, 0.4, or even 0.5 for a face velocity of 13.8 cm/s when tested according to the Filtration Performance Test Method, as described in the forthcoming examples. More preferably, the initial Quality Factor is at least 0.6 or 0.7. In some embodiments, the initial Quality Factor is at least 0.8, at least 0.90, at least 1.0, or even greater than 1.0. To test the performance of the filter web, the filter web is challenged with x-rays at room temperature (e.g., 23° C.) for a specified time and the Quality Factor is measured again. In one embodiment, the Quality Factor after 40 minutes exposure to x-rays is typically at least 50% less than the initial Quality Factor.

In one embodiment, the ratio of the Quality Factor of the challenged filter web (Q3) to the Quality Factor of the initial web (Q0) is at least 0.75, 0.80, 0.85, 0.90, or even 0.95, with 1.00 representing no change in charge retention after challenging.

In order for the web to have sufficient charge for use as a filter, the % Penetration Ratio is typically at least 50%. As the % Penetration Ratio increase, the filtration performance of the web also increases. In some embodiments, the % Penetration Ratio is at least 55%, 60%, or 70%. In preferred embodiments, the % Penetration Ratio is at least 75% or 80%. In some embodiments, the unitary web exhibits a % Penetration Ratio of at least 85%, at least, or at least 95%.

In one embodiment, filter webs made with the core-sheath fibers of the present disclosure have oil repellency test of at least 3, 4 or even 5, as measured by the Oil Repellency Test disclosed herein.

### Examples

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods.

TABLE 1
Materials List

| Abbreviation | Description and Source |
|---|---|
| PP | Polypropylene resin, grade M3766, available from Total Petrochemicals, |
| | Houston, TX |
| HDPE | High density polyethylene, grade HD-3733.17, available from Channel |
| | Prime Alliance, Des Moines, IA |
| PLA | Polylactic acid, grade 6100D, available from NatureWorks, Minnetonka, |
| | Minnesota |
| CA-1 | A phenolate salt, prepared as described in U.S. Pat. Application Publ. |
| | No. 2019/0003112 (Schultz et al.) [Phenol 9-Ca] |
| CA-2 | N,N'-bis(2,2,6,6-tetramethylpiperidin-4-yl)hexane-1,6-diamine;2,4,6- |
| | trichloro-1,3,5-triazine;2,4,4-trimethylpentan-2-amine |
| | (Chimassorb944/CAS No. 71878-19-8), Available from BASF SE, |
| | Ludwigshafen am Rhein, Germany |
| CA-3 | 1,3-Dihydro-4(or 5)-methyl-2H-benzimidazole-2-thione, zinc salt |
| | (ZMTI/CAS No. 61617-00-3); Available from Vanderbilt Chemicals, |
| | LLC, Norwalk, Connecticut |
| PMA-1 | A fluoromelt additive, prepared as described in PE6 in WO 2017/100045 |

Filtration Performance Test Method, Non-Woven Webs

Initial Filtration Performance

The samples were tested for % aerosol penetration (% Pen) and pressure drop (ΔP), and the quality factor (QF) was calculated from these two values. The filtration performance (% Pen and QF) of the nonwoven microfiber webs were evaluated using an Automated Filter Tester AFT Model 8130 (available from TSI, Inc., St. Paul, MN) using dioctylphthalate (DOP) as the challenge aerosol and a pressure transducer that measured pressure drop (ΔP (mm of H₂O)) across the filter. The DOP aerosol was nominally a monodisperse 0.33 micrometer mass median diameter (MMD) having an upstream concentration of 50-200 mg/m³ and a target of 100 mg/m³. The aerosol was forced through a sample of filter media at a calibrated flow rate of 85 liters/minute (face velocity of 13.8 cmi/s). The aerosol ionizer was turned off for these tests. The total testing time was 23 seconds (rise time of 15 seconds, sample time of 4 seconds, and purge time of 4 seconds). The concentration of DOP aerosols was measured by light scattering both upstream and downstream of the filter media using calibrated photometers. The DOP % Pen is defined as: % Pen=100×(DOP concentration downstream/DOP concentration upstream). For each material, 6 separate measurements were made at different locations on the web and the results were averaged.

The initial Quality Factor (Q0) was determined. For the Q3 value, six samples were thermally aged at 72° C. for 3 days (ambient humidity) and then the Quality Factor was determined and the average of these six QFs was reported as Q3.

Oil Repellency Test

The webs are all tested for oil repellency using 3M Oil Repellency Test I (Drop Test) (April 2020). In this test, samples are challenged to penetration by oil or oil mixtures of varying surface tensions. Oils and oil mixtures are given a rating corresponding to the following table:

TABLE 2
Oil Repellency Values

| Oil | | |
|---|---|---|
| Rating | dynes/cm | Oil Composition |
| 0 | >31 | fails Kaydol mineral oil |
| 1 | 31.0 | Kaydol mineral oil |
| 2 | 28.0 | 65/35 (vol) mineral oil/ |
| | | n-hexadecane |
| 3 | 26.5 | n-hexadecane |
| 4 | 25.5 | n-tetradecane |
| 5 | 24.0 | n-dodecane |
| 6 | 22.0 | n-decane |
| 7 | 20.5 | n-octane |
| 8 | 18.5 | n-heptane |

Fiber and Non-Woven Sample Preparation

Step A—Fiber and Web Formation:

For each example, the filtration media was formed by first dry blending a charging additive (if applicable) with a resin (as listed in the tables below) and then extruding fibers into a spunbond web using a core-sheath die. The nominal web specifications used are listed in Table 3 below and they will be referred to as Spec 1, Spec 2, and Spec 3.

TABLE 3

| | Basis Weight | Solidity | Δ P |
|---|---|---|---|
| | (g/m²) | (%) | (mm H₂O) |
| Spec 1 | 65 | 10.0 | 1.55 |
| Spec 2 | 100 | 11.0 | 2.50 |
| Spec 3 | 65 | 9.7 | 1.10 |

Step B—Electret Preparation:

Each of the spunbond webs in Step A was charged by one of the following electret charging methods: corona charging, hydrocharging, or corona pre-treatment followed by hydrocharging. The methods are designated as Charging Method C, H, and CH, respectively.

Charging Method C—Corona Charging:

The corona charging was accomplished by passing the web on a grounded surface under a corona brush source with a corona current of about 0.01 milliamp per centimeter of discharge source length at a rate of about 3 centimeters per second. The corona source was about 3.5 centimeters above the grounded surface on which the web was carried. The corona source was driven by a positive DC voltage.

Charging Method H—Hydrocharging:

A fine spray of high purity water having a conductivity of less than 5 microSiemens/cm was continuously generated from a nozzle operating at a pressure of 896 kiloPascals (130 psig) and a flow rate of approximately 1.4 liters/minute. Selected webs prepared in Step A were conveyed by a porous belt through the water spray at a speed of approximately 10 centimeters/second while a vacuum simultaneously drew the water through the web from below. Each web was run through the hydrocharger twice (sequentially once on each side) and then allowed to dry completely overnight prior to filter testing.

Charging Method CH—Corona Pre-Treatment and Hydrocharging:

Selected webs prepared in Step A above were pretreated by DC corona discharge as described in Charging Method C and then charged by hydrocharging as described in Charging Method H.

Effective Fiber Diameter (EFD)

EFD is calculated from the pressure drop, a targeted thickness of about 0.028 in (for Spec 1) and 0.047 in (for Spec 2), and a face velocity of 13.8 cm/sec at 1 atmosphere. The pressure drop is determined as follows: A high-speed automated filter tester (obtained under the trade designation “8130” from TSI Inc., Shoreview, MN) was operated with particle generation and measurement turned off. Flowrate was adjusted to 85 liters per minute (LPM) and a 5.25 in (13.34 cm) diameter sample was used. The sample was placed onto the lower circular plenum opening and the tester was engaged. A pressure transducer (obtained from MKS Instruments, Inc., Andover, MA) within the device measured the pressure drop in mm H₂O. Based on the measured pressure drop, the Effective Fiber Diameter can be calculated as set forth in C. N. Davies, The Separation of Airborne Dust and Particulates, Institution of Mechanical Engineers, London Proceedings, IB (1952).

Sheath Thickness

The effective sheath thickness for selected samples was computed using the equation below. This equation is derived using a volumetric S/C ratio assuming a cylindrical cross-section.

rₛₕₑₐₜₕ=(d/2)−[C_{vol %}/100×(d/2)]^{(1/2)}

where rₛₕₑₐₜₕ is the radius of the sheath, d is the diameter of the core-sheath fiber as determined by the EFD, and C_{vol %} is the percent volume of core (based on the S/C ratio). Shown in Table 5 below is the EFD (effective fiber diameter) for the samples and the calculated sheath thickness.

TABLE 4
Example 1 (Ex 1) and Comparative Example 1 (CE 1)

| Sample | Web | | S/C* Ratio | | | | |
|---|---|---|---|---|---|---|---|
| Number | Spec | Composition | by volume | Treatment | Q0 | Q3 | Q3/Q0 |
| CE 1-1 | Spec 1 | PP - Neat | NA | CH | 0.34 | 0.31 | 0.91 |
| | | | | C | 0.33 | 0.23 | 0.70 |
| CE 1-2 | Spec 1 | PP + 0.1% CA-1 | NA | CH | 0.47 | 0.47 | 1.00 |
| | | | | C | 0.44 | 0.44 | 1.00 |
| Ex 1-1 | Spec 1 | S* = PP | 60/40 | CH | 0.40 | 0.36 | 0.90 |
| | | C = PP + 0.1% CA-1 | | C | 0.36 | 0.35 | 0.97 |
| Ex 1-2 | Spec 1 | S = PP | 50/50 | CH | 0.44 | 0.45 | 1.02 |
| | | C = PP + 0.1% CA-1 | | C | 0.40 | 0.34 | 0.85 |
| Ex 1-3 | Spec 1 | S = PP | 30/70 | CH | 0.46 | 0.52 | 1.13 |
| | | C = PP + 0.1% CA-1 | | C | 0.40 | 0.42 | 1.05 |

*S stands for sheath and C stands for core and NA stands for not applicable

TABLE 5

| | | Sheath |
|---|---|---|
| Sample | EFD | thickness |
| Number | micron | micron |
| CE-1-1 | 15.2 | 7.6 |
| Ex 1-1 | 16.0 | 2.9 |
| Ex 1-2 | 16.0 | 2.3 |
| Ex 1-3 | 15.9 | 1.3 |

TABLE 6
Example 2

| Sample | Web | | | | | | |
|---|---|---|---|---|---|---|---|
| Number | Spec | Composition | S/C Ratio | Treatment | Q0 | Q3 | Q3/Q0 |
| Ex 2-1 | Spec 1 | S = HDPE | 50/50 | C | 0.27 | 0.29 | 1.07 |
| | | C = PP + 0.1% CA-1 | | | | | |
| Ex 2-2 | Spec 1 | S = HDPE | 30/70 | C | 0.30 | 0.30 | 1.00 |
| | | C = PP + 0.1% CA-1 | | | | | |
| Ex 2-3 | Spec 1 | S = HDPE | 15/85 | C | 0.36 | 0.36 | 1.00 |
| | | C = PP + 0.1% CA-1 | | | | | |

TABLE 7
Example 3 (Ex 3) and Comparative Example 3 (CE 3)

| Sample | | | | | | | |
|---|---|---|---|---|---|---|---|
| Number | Web Spec | Composition | S/C Ratio | Treatment | Q0 | Q3 | Q3/Q0 |
| CE 3-1 | Spec 1 | PP - neat | NA | C | 0.50 | 0.43 | 0.86 |
| | | | | CH | 0.73 | 0.44 | 0.60 |
| CE 3-2 | Spec 1 | PP w/0.1% CA-1 | NA | C | 0.54 | 0.60 | 1.11 |
| | | | | CH | 0.69 | 0.75 | 1.09 |
| Ex 3-1 | Spec 1 | S = PP | 30/70 | C | 0.54 | 0.50 | 0.93 |
| | | C = PP w/0.1% CA-1 | | CH | 0.69 | 0.70 | 1.01 |

TABLE 8
Example 4 (Ex 4) and Comparative Example 4 (CE 4)

| Sample | Web | | S/C | | | | |
|---|---|---|---|---|---|---|---|
| Number | Spec | Composition | Ratio | Treatment | Q0 | Q3 | Q3/Q0 |
| CE 4-1 | Spec 1 | S = PP (Neat) | NA | C | 0.31 | 0.27 | 0.87 |
| | | C = PP (Neat) | | | | | |
| Ex 4-1 | Spec 1 | S = PP (Neat) | 30/70 | C | 0.36 | 0.40 | 1.12 |
| | | C = PP (0.1% CA-1) | | | | | |
| CE 4-2 | Spec 1 | S = PP (1% CA-2) | 30/70 | C | 0.33 | 0.34 | 1.03 |
| | | C = PP (Neat) | | H | 0.82 | 0.85 | 1.04 |
| Ex 4-2 | Spec 1 | S = PP (1% CA-2) | 30/70 | C | 0.39 | 0.43 | 1.10 |
| | | C = PP (0.1% CA-1) | | H | 0.92 | 0.87 | 0.95 |

TABLE 9
Example 5 (EX 5) and Comparative Example 5 (CE 5)

| Sample | Web | | S/C | | | | |
|---|---|---|---|---|---|---|---|
| Number | Spec | Composition | Ratio | Treatment | Q0 | Q3 | Q3/Q0 |
| CE 5 | Spec 1 | S = HDPE(Neat) | 30/70 | C | 0.18 | 0.17 | 0.94 |
| | | C: PP | | | | | |
| Ex 5-1 | Spec 1 | S = HDPE(Neat) | 30/70 | C | 0.21 | 0.21 | 1.00 |
| | | C = PP (0.2% CA-3) | | | | | |
| Ex 5-2 | Spec 1 | S = HDPE(Neat) | 30/70 | C | 0.26 | 0.23 | 0.88 |
| | | C = PP (0.2% CA-1) | | | | | |
| Ex 5-3 | Spec 1 | S = HDPE(1% CA-2) | 30/70 | C | 0.37 | 0.34 | 0.92 |
| | | C = PP (0.2% CA-3) | | | | | |

TABLE 10
Example 6 (Ex 6) and Comparative Example 6 (CE 6)

| Sample | Web | | S/C | | | | |
|---|---|---|---|---|---|---|---|
| Number | Spec | Composition | Ratio | Treatment | Q0 | Q3 | Q3/Q0 |
| CE 6 | Spec 1 | S = PLA (Neat) | 30/70 | C | 0.51 | 0.42 | 0.83 |
| | | C = PLA (Neat) | | | | | |
| Ex 6-1 | Spec 1 | S = PLA (Neat) | 30/70 | C | 0.42 | 0.40 | 0.96 |
| | | C = 3766(0.1% CA-1) | | | | | |
| Ex 6-2 | Spec 1 | S = PLA (Neat) | 30/70 | C | 0.45 | 0.46 | 1.01 |
| | | C = 3766(0.1 CA-3) | | | | | |

TABLE 11
Example 7 (EX 7) and Comparative Example 7 (CE 7)

| Sample | Web | | S/C | | |
|---|---|---|---|---|---|
| Number | Spec | Composition | Ratio | Treatment | Q0 |
| CE 7 | Spec 3 | PP-neat | NA | CH | 0.44 |
| | | | | H | 0.18 |
| Ex 7-1 | Spec 3 | S = PP Neat | 20/80 | CH | 0.69 |
| | | C = PP + 0.8% CA-2 | | H | 1.04 |
| Ex 7-2 | Spec 3 | S = PP Neat | 30/70 | CH | 0.42 |
| | | C = PP + 0.8% CA-2 | | H | 0.71 |
| Ex 7-3 | Spec 3 | S = PP Neat | 40/60 | CH | 0.42 |
| | | C = PP + 0.8% CA-2 | | H | 0.71 |

In Table 12, the web of Ex 8-2 was annealed at 110° C. for 10 minutes before charging. As shown in Table 12, there is virtually no impact on Q0 or Q3.

TABLE 12
Example 8 (Ex 8)

| Sample | | | S/C | | | | |
|---|---|---|---|---|---|---|---|
| Number | Web Spec | Composition | Ratio | Treatment | Q0 | Q3 | Annealed |
| Ex 8-1 | Spec 1 | S: PP + 1% PMA-1 Core: PP + | 30/70 | CH | 0.44 | 0.44 | No |
| | | 0.15% CA-1 | | | | | |
| Ex 8-2 | Spec 1 | S: PP + 1% PMA-1 Core: PP + | 30/70 | CH | 0.46 | 0.44 | Yes |
| | | 0.15% CA-1 | | | | | 110° C. |

In Table 13, the webs were annealed as specified for 10 minutes before charging. As shown in Table 13, oil resistance is imparted upon annealing.

TABLE 13
Example 8 (Ex 8) and Comparative Example 8 (CE 8)

| | | | | | Oil |
|---|---|---|---|---|---|
| | | Web | S/C | Annealing | Drop |
| Sample | Composition | Spec | Ratio | Conditions | Value |
| CE 8-1 | PP-neat | Spec 1 | 100/0 | 90° C./ | 0 |
| | | | | 10 min | |
| CE 8-2 | PP-neat | Spec 1 | 100/0 | 100° C./ | 0 |
| | | | | 10 min | |
| CE 8-3 | PP-neat | Spec 1 | 100/0 | 110° C./ | 0 |
| | | | | 10 min | |
| CE 8-4 | PP-neat | Spec 1 | 100/0 | 130° C./ | 0 |
| | | | | 10 min | |
| Ex 8-1 | S = PP + 1% PMA-1 | Spec 1 | 30/70 | 90° C./ | 0 |
| | C = PP + 0.15% CA-1 | | | 10 min | |
| Ex 8-2 | S = PP + 1% PMA-1 | Spec 1 | 30/70 | 100° C./ | 0 |
| | C = PP + 0.15% CA-1 | | | 10 min | |
| Ex 8-3 | S = PP + 1% PMA-1 | Spec 1 | 30/70 | 110° C./ | 3 |
| | C = PP + 0.15% CA-1 | | | 10 min | |
| Ex 8-4 | S = PP + 1% PMA-1 | Spec 1 | 30/70 | 120° C./ | 5 |
| | C = PP + 0.15% CA-1 | | | 10 min | |
| Ex 8-5 | S = PP + 1% PMA-1 | Spec 1 | 30/70 | 130° C./ | 5 |
| | C = PP + 0.15% CA-1 | | | 10 min | |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A thermoplastic core-sheath fiber comprising:
a core having a coextensive sheath layer disposed thereon, wherein the core comprises a first polymeric resin and an electrostatic charge enhancing additive, and the sheath comprises a second polymeric resin and wherein the sheath is substantially free of an electrostatic charge enhancing additive, with the proviso that if the second polymeric resin comprises poly(4-methyl-1-pentene), then the second polymeric resin does not comprise 100 wt % of poly(4-methyl-1-pentene).

2. The thermoplastic core-sheath fiber of claim 1, wherein the sheath has a thickness of at least 0.1 micrometers and at most 3 micrometers.

3. The thermoplastic core-sheath fiber of claim 1, wherein the volume ratio of the sheath to the core is at least 60:40.

4. (canceled)

5. (canceled)

6. The thermoplastic core-sheath fiber of claim 1, wherein the core comprises at least 0.1% by weight of the electrostatic charge enhancing additive.

7. The thermoplastic core-sheath fiber of claim 1, wherein the charge enhancing additive is selected from the group consisting of pigments, light stabilizers, primary and secondary antioxidants, metal deactivators, hindered amines, hindered phenols, metal salts, phosphite triesters, phosphoric acid salts, fluorine-containing compounds, and combinations thereof.

8. The thermoplastic core-sheath fiber of claim 1, the core-sheath fiber has a diameter of at least 4 micrometers.

9. The thermoplastic core-sheath fiber of claim 1, wherein the core comprises polypropylene.

10. The thermoplastic core-sheath fiber of claim 1, wherein the second polymeric resin comprises at least one of polypropylene, polyethylene, polylactic acid, polyester, or polystyrene.

11. The thermoplastic core-sheath fiber of claim 1, wherein the core-sheath fiber has an electret charge.

12. The thermoplastic core-sheath fiber of claim 1, wherein the sheath layer comprises a fluorinated compound.

13. The thermoplastic core-sheath fiber of claim 1, wherein the first polymeric resin and the second polymeric resin comprise the same polymer.

14. A nonwoven fibrous web comprising the thermoplastic core-sheath fibers according to claim 1.

15. A medical article comprising the nonwoven fibrous web of claim 14.

16. A filtering article comprising the nonwoven fibrous web of claim 14.

17. The filtering article of claim 16, wherein the filtering article is a respirator.

18. The filter article of claim 16, wherein the nonwoven fibrous web is pleated.

19. A method of making an electret, the method comprising:
(i) providing a thermoplastic core-sheath fiber comprising a core having a coextensive sheath layer disposed thereon, wherein the core comprises a first polymeric resin and an electrostatic charge enhancing additive and wherein the sheath is substantially free of an electrostatic charge enhancing additive with the proviso that if the second polymeric resin comprises poly(4-methyl-1-pentene), then the second polymeric resin does not comprise 100 wt % of poly(4-methyl-1-pentene); and
(ii) charging the thermoplastic core-sheath fiber via corona treatment, hydrocharging, tribocharging, or combinations thereof to form the electret.
